(19) United States
(12) Patent Application Publication
(10) Pub. No.: US 2010/0294089 A1
(43) Pub. Date: Nov. 25, 2010

(54) UNIVERSAL TOOL EXTENSION ROD

(75) Inventor: Ssu-Cheng LAI, Changhua City (TW)

Correspondence Address: EGBERT LAW OFFICES, 412 MAIN STREET, 7TH FLOOR, HOUSTON, TX, 77002, US

(73) Assignee: FOUR SQUARES Co., Ltd., Changhua City (TW)

(21) Appl. No.: 12/471,434

(22) Filed: May 25, 2009

(51) Int. Cl. B25B 23/00; B25B 29/00

(52) U.S. Cl. 81/177.6; 81/177.85

(57) ABSTRACT

The present invention provides a universal tool extension rod, including a plurality of universal coupling sleeves and first and second end joints. A corresponding polygonal sphere and polygonal driver are mated between universal coupling sleeves, and the polygonal sphere can slide within the polygonal driver in straight mating or universally flexible states. The first and second end joints can be linked with the universal coupling sleeves similarly, so that the tool extension rod can be combined into a straight state or unhinged into a universally bending state where necessary. Both operating states can realize universality, robustness and durability due to multi-angle ability, high torsion and extensibility.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a tool extension rod, and more particularly to an innovative extension rod which features multi-angle, high torsion and extensibility suitable for curved or straight spaces.

2. Description of Related Art Including Information Disclosed Under 37 CFR 1.97 and 37 CFR 1.98

Generally, the screw bolts and nuts can be easily tightened or loosened by open spanners or socket wrenches in a flat and open environment; however, neither open spanners and socket wrenches can be extended into narrow or deep spaces, where some tool extension rods must be provided to extend the working ends of the open spanners or socket wrenches.

However, the commercially available tool extension rods, which are generally straight shapes, are not suitable for curved and depressed narrow spaces other than straight ones. A lot of time will be spent to realize the operation in such environment, especially for automobile maintenance and repair work.

The typical technologies associated with this field of invention include a two-section tool extension rod disclosed by Taiwanese Patent No. M336848, a tool joint disclosed by Taiwanese Patent No. M340894, and a tool joint disclosed by Taiwanese Patent No. M342921.

Notwithstanding the existing tool extension rods (or joints) that enable curved driving operation with a universal swinging end, these short-pitch mechanisms without an extension rod cannot resolve the aforementioned problems for operation in curved and depressed narrow spaces, so there is still room for improvement.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

There is enhanced efficacy of the present invention.

Based on the unique present invention, the universal tool extension rod mainly comprises a plurality of universal coupling sleeves and a first and a second end joint. The polygonal sphere and polygonal driver are mated between the universal coupling sleeves, and the polygonal sphere can slide flexibly within the polygonal driver in straight mating or universally flexible states. The tool extension rod hereto can be combined into a straight state or unhinged into universally bending state where necessary. Moreover, both operating states can realize universality, robustness and durability due to multi-angle, high torsion and extensibility.

There are improvements brought about by this invention.

Based on the structure of the present invention, a polygonal shoulder can be embedded into the polygonal driver, together with the directional positioning of the polygonal sphere and polygonal driver. The universal coupling sleeve and first and second end joints of the universal tool extension rod can be mated straightly featuring excellent robustness, applicability and durability as well as strong withstanding of big torsion.

Based on the structure of the elastic locating member, the universal coupling sleeves can be mated more compactly and securely.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows an assembled perspective view of preferred embodiment of the present invention.

FIG. 2 shows an exploded perspective view of some components of the present invention.

FIG. 3 shows an assembled sectional view of the present invention in a straight mating state.

FIG. 4 shows an assembled sectional view of the present invention in an unhinged state.

FIG. 5 shows an assembled sectional view of the present invention in a bending state.

FIG. 6 shows a sectional view of the present invention that the polygonal sphere is mated with the polygonal driver.

FIG. 7 shows a perspective view of the present invention in a bending state.

FIG. 8 shows an elevation view of the application of the present invention, showing that the universal tool extension rod can be suited for curved and depressed narrow spaces.

FIG. 9 shows a perspective view of an application of the present invention, showing that the spacing member and elastic locating member are formed by an O-ring.

FIG. 10 shows a sectional view of an application of the present invention, showing that the elastic locating member is formed by an elastic friction ball.

### DETAILED DESCRIPTION OF THE INVENTION

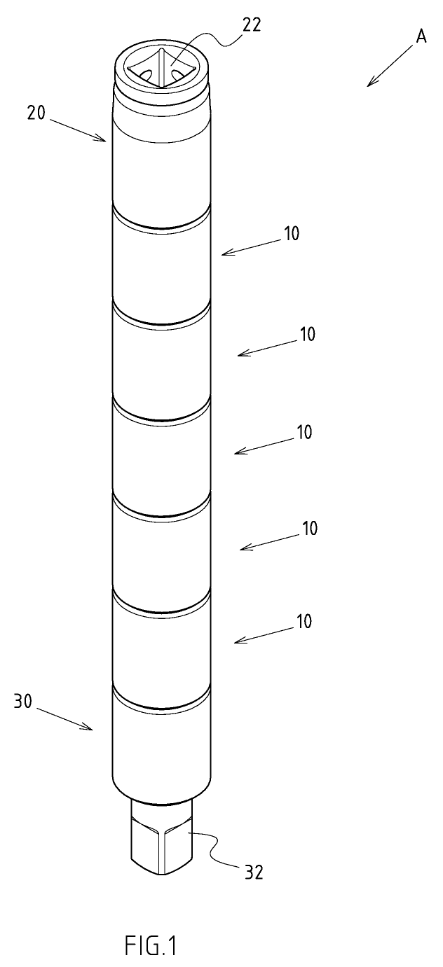

FIGS. 1˜3 depict preferred embodiments of a universal tool extension rod of the present invention. The embodiments are provided for only explanatory objectives with respect to the patent claims.

The universal tool extension rod A comprises a plurality of universal coupling sleeves 10, a first end joint 20, and a second end joint 30.

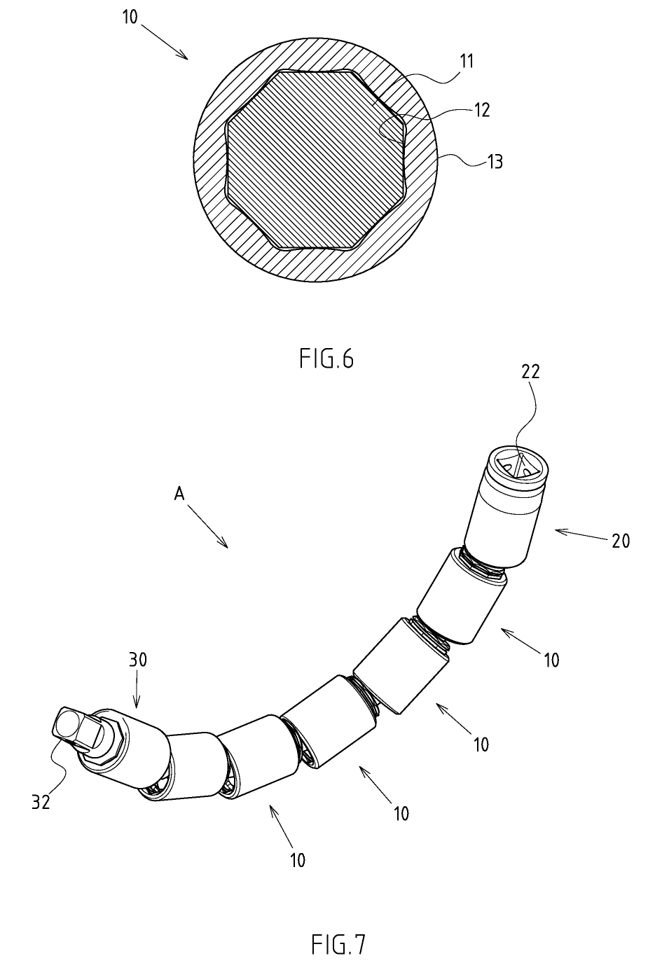

Both ends of the universal coupling sleeve 10 are separately provided with a protruding polygonal sphere 11 and a cylinder 13 fitted with a polygonal driver 12. The cross sections of the polygonal sphere 11 and the polygonal driver 12 are mated (shown in FIG. 6), while the polygonal sphere 11 is linked with the cylinder 13 via a reducing main column 14.

The polygonal sphere 11 can slide flexibly in the polygonal driver 12 within the set stroke. When the polygonal sphere 11 shifts outwards, the main column 14 can be extended outwards for a swinging state.

A spacing member 40 is arranged nearby the polygonal driver 12, so that the shift state of polygonal sphere 11 can be limited. The spacing member 40 of the preferred embodiment is a C-shaped snap ring 41, such that the polygonal driver 12 is fitted with a circular groove 120 for embedding and positioning of the C-shaped snap ring 41.

The main column 14 is provided with a polygonal shoulder 15 nearby the cylinder 13, so that when the polygonal sphere 11 shifts inwards, the polygonal shoulder 15 can be embedded into the polygonal driver 12 for directional mating.

The polygonal shoulder 15 is also provided with an elastic locating member 50, which is abutted tightly with the corresponding polygonal driver 12 for positioning effect. The elastic locating member 50 maybe a C-shaped snap ring 51, so that the polygonal shoulder 15 is fitted with a circular slot 150 for embedding and positioning of the C-shaped snap ring 51. Moreover, a circular locating slot 121 is placed correspondingly to the polygonal driver 12 and aligned with the C-shaped snap ring 51 for locking purpose.

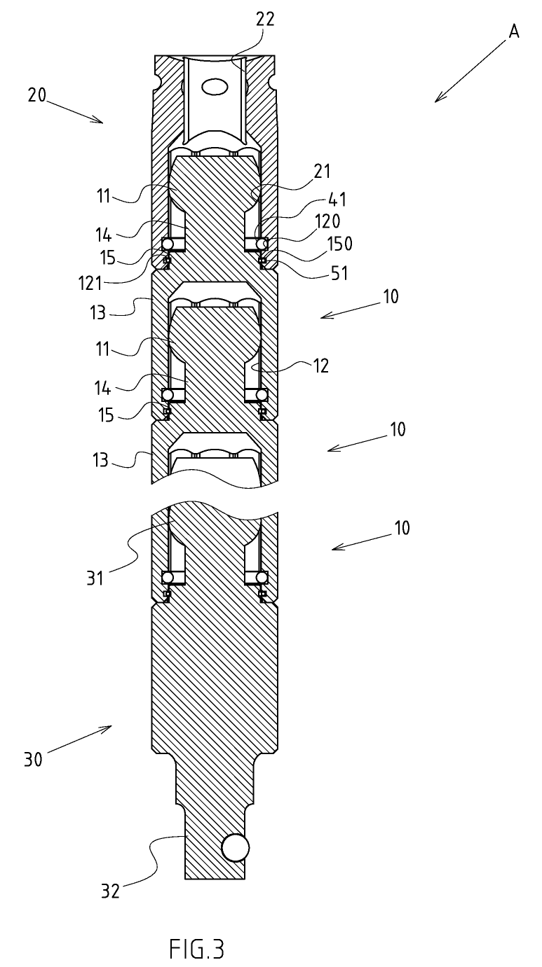

At one end of the first end joint 20, a polygonal driver 21 is coupled securely with the polygonal sphere 11 of a universal coupling sleeve 10 set at the top (with regard to the position shown in FIGS. 1, 3). The other end of the first end joint 20 is provided with a first coupling portion 22, which may be a square slot for inserting the square head of existing spanner or T-shaped tommy bar.

At one end of the second end joint 30, a polygonal sphere 31 is coupled securely with the polygonal driver 12 of a universal coupling sleeve 10 set at the top (with regard to the position shown in FIGS. 1, 3). The other end of the second end joint 30 is provided with a second coupling portion 32, which may be a square bulge for inserting existing sleeves or for direct usage.

Based upon above-specified structure, the present invention is operated as follows:

The universal tool extension rod A can be used in straight or universally flexible states where necessary. Referring first to FIGS. 1 and 3, the universal coupling sleeves 10, or the first and second end joints 20, 30 and universal coupling sleeves 10 are abutted tightly into a straight state, namely, the polygonal sphere 11 is shifted inwards the corresponding polygonal driver 12. In such a case, the polygonal shoulder 15 is also embedded into the polygonal driver 12 for positioning purpose, other than directional positioning between the polygonal sphere 11 and polygonal driver 12. The elastic locating member 50 can be used additionally for positioning purposes, without mentioning the same coupling structure between the first and second end joints 20, 30 and universal coupling sleeve 10. With this invention, the universal coupling sleeves 10 and the first and second end joints 20, 30 can be mated straightly and stably to bear extremely big torsional force, providing the same effect like existing tool extension rod with straight rod.

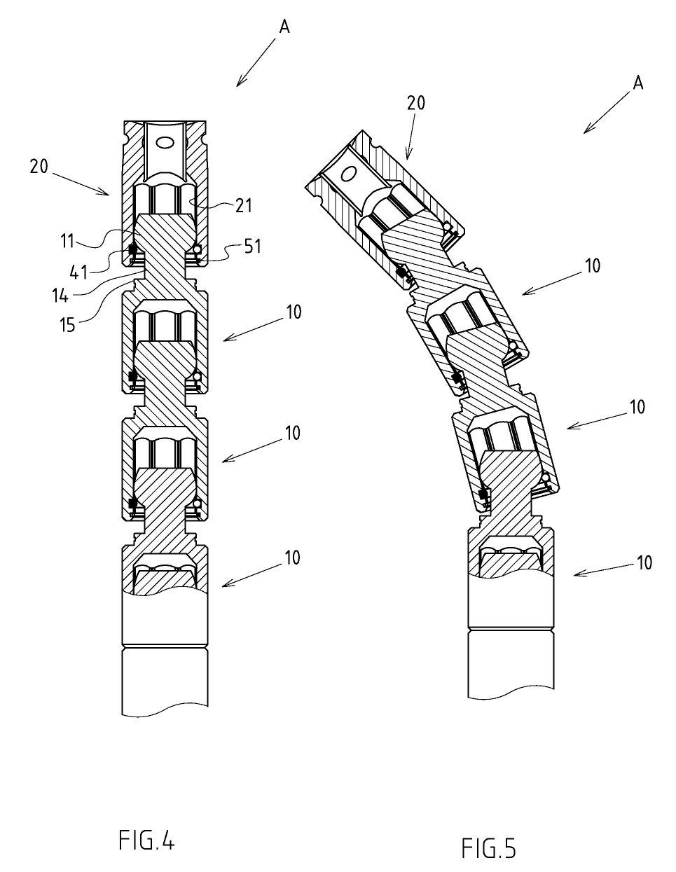

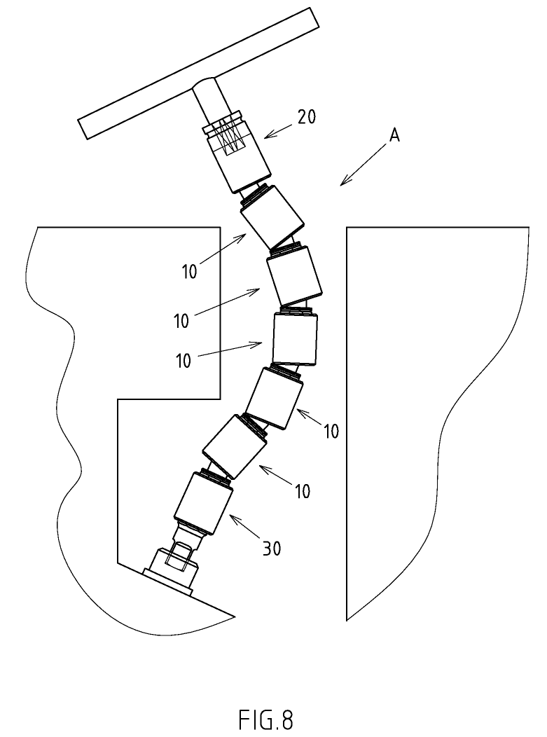

Referring also to FIG. 4, the universal coupling sleeves 10, or the first and second end joints 20, 30 and the universal coupling sleeve 10 can also be unhinged so that the main columns 14 can be extended into a swinging state. In such a case, the universal coupling sleeve 10, the first and second end joints 20, 30 can swing universally. With the directional mating of the polygonal sphere 11 and polygonal driver 12 (shown in FIG. 6), the universal tool extension rod A can be bended flexibly with respect to its shape (shown in FIGS. 5, 7), enabling the universal coupling sleeve 10 and the first and second end joints 20, 30 to rotate extremely stably and robustly while bearing extremely big torsional force. So, the universal tool extension rod A of the present invention can resolve the existing problem of tightening and loosening the screw bolts and nuts within the curved and depressed narrow spaces (shown in FIG. 8) under special working environment.

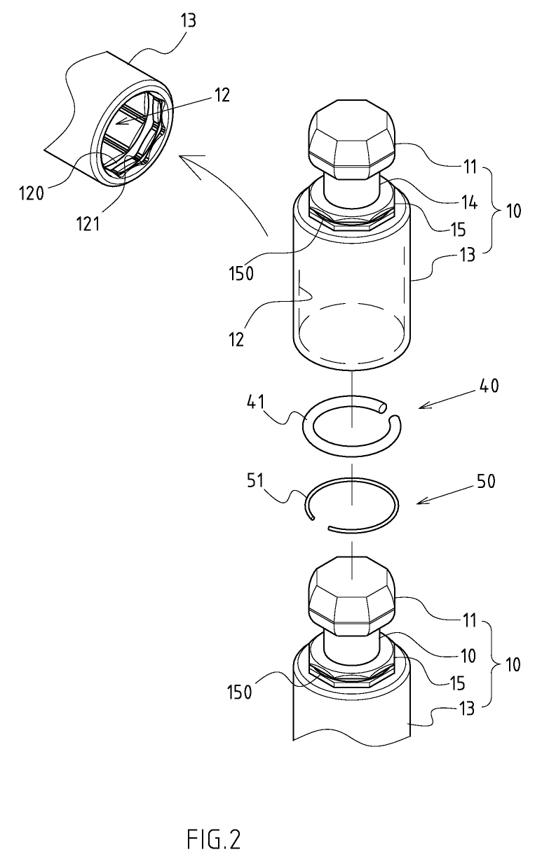

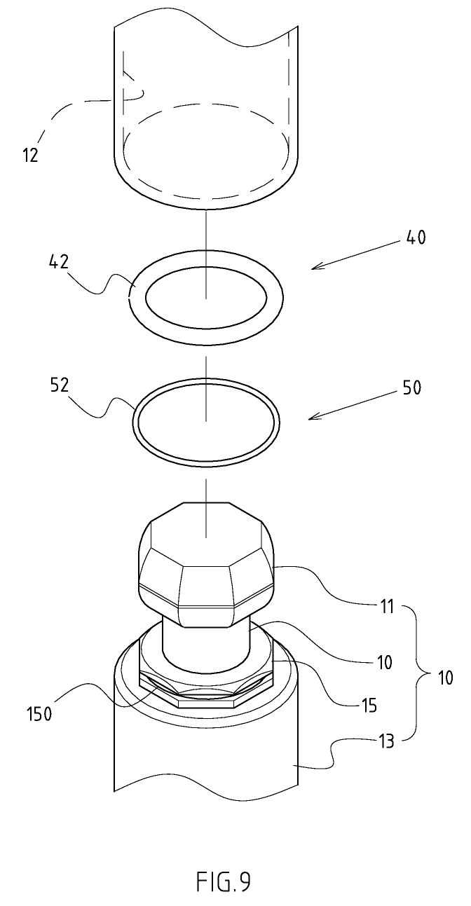

Referring also to FIG. 9, the spacing member 40 can also be formed by an O-ring 42 made of rubber or plastic or metal material. A circular groove 120 (shown in FIG.2) is also arranged within the polygonal driver 12 for embedding and positioning of O-ring 42.

Referring also to FIG. 9, the elastic locating member 50 can also be formed by an O-ring 52 made of rubber or plastic or metal material, allowing for positioning via direct friction with the corresponding polygonal driver 12.

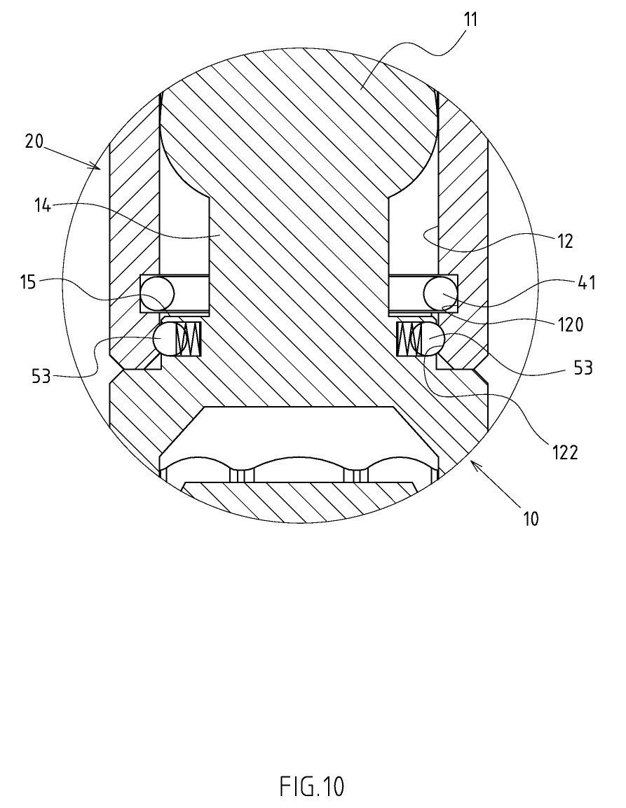

Referring also to FIG. 10, the elastic locating member 50 can also be formed by an elastic friction ball 53, which polygonal driver 12 has an inlay groove that has an arc cross-section, so as for the elastic friction ball 53 to be locked for positioning.

1. A universal tool extension rod comprising:
a plurality of universal coupling sleeves, each sleeve being separately provided with a protruding polygonal sphere and a cylinder fitted with a polygonal driver, the polygonal sphere and said polygonal driver having mated cross sections, the polygonal sphere being linked with said cylinder via a reducing main column, the polygonal sphere being flexibly slideable in said polygonal driver within a set stroke, when the polygonal sphere shifts outwards, said main reducing column being extended outward in a swinging state;
a spacing member arranged nearby the polygonal driver, limiting a shift state of the polygonal sphere, said main reducing column having a polygonal shoulder near said cylinder, when the polygonal sphere shifts inward, said polygonal shoulder being embedded into said polygonal driver for directional mating, said polygonal shoulder having an elastic locating member abutted tightly with a corresponding polygonal driver for positioning;
a first end joint, having one end with a polygonal driver coupled securely with a polygonal sphere of a universal coupling sleeve set at a top and another end provided with a first coupling portion; and
a second end joint having one end with a polygonal sphere coupled securely with a polygonal driver of a universal coupling sleeve set at a top and another end provided with a second coupling portion, wherein the universal coupling sleeves and the first and second end joints form a straight state or unhinge into universally bending state.

2. The universal tool extension rod defined in claim 1, wherein the spacing member of the polygonal driver is a C-shaped snap ring, the polygonal driver being fitted with a circular groove for embedding and positioning of the C-shaped snap ring.

3. The universal tool extension rod defined in claim 1, wherein the spacing member of the polygonal driver is an O-ring, the polygonal driver being fitted with a circular groove for embedding and positioning of the O-ring.

4. The universal tool extension rod defined in claim 1, wherein the elastic locating member is a C-shaped snap ring, said polygonal shoulder being fitted with a circular slot for embedding and positioning of the C-shaped snap ring; and wherein a circular locating slot is placed correspondingly to the polygonal driver and aligned with the C-shaped snap ring for locking.

5. The universal tool extension rod defined in claim 1, wherein the elastic locating member is an O-ring, positioned via direct friction with a corresponding polygonal driver.

6. The universal tool extension rod defined in claim 1, wherein the elastic locating member is an elastic friction ball, a corresponding polygonal driver having an inlay groove for the elastic friction ball to be locked for positioning.

7. The universal tool extension rod defined in claim 1, wherein the first coupling portion of the first end joint is a square slot, and wherein the second coupling portion of the second end joint is a square bulge.
